(19) United States
(12) Patent Application Publication
(10) Pub. No.: US 2025/0223406 A1
(43) Pub. Date: Jul. 10, 2025

(54) EFFICIENT METHOD FOR BRANCHED AMINO AND CARBOXYLATED NATURAL OILS WITH CHOLINE CHLORIDE

(71) Applicant: Ohio Soybean Council, Worthington, OH (US)

(72) Inventors: Robert J. Cain, Lewis Center, OH (US); Dylan Karis, Delaware, OH (US); Grant Proulx, Maitland, FL (US)

(21) Appl. No.: 19/014,690

(22) Filed: Jan. 9, 2025

Related U.S. Application Data
(60) Provisional application No. 63/619,194, filed on Jan. 9, 2024.

(51) Int. Cl. C08J 3/09

(52) U.S. Cl. CPC C08J 3/095; C08J 2479/02; C08J 2479/08

(57) ABSTRACT

This invention describes branched amino and carboxylated natural oils. The chemistries are derived from plant-based epoxidized oils, alkanol amines, citric acid, and choline chloride. The process described has 100% atom efficiency and no waste.

### RELATED APPLICATIONS

This application claims priority to U.S. Provisional Patent Application Ser. No. 63/619,194, filed on Jan. 9, 2024, the entirety of which is incorporated herein by reference.

### BACKGROUND

Acidic chemistries have utility in a variety of industrial applications, most notably in processes or applications involving metals (alkali metal, alkali earth metals, transition metals). Examples could include hard water scale inhibition (e.g. calcium, barium, iron, and magnesium salts), cleaning of scale deposits (e.g. salts of carbonates and sulfates), and rust removers (e.g. oxides and hydroxides of ferrous metals like iron and steel).

Scale inhibitors are employed in water systems to prevent the accumulation of precipitated incompatible salts that can build up in pipelines, valves, and pumps. This is particularly troublesome during drilling operations like oil production and processing. The most common inorganic salts that produce scale consist of calcium, magnesium, barium, and iron. Without continuous maintenance scale can build up within pipes, plumbing and pumps, restricting flow or rendering them inoperable. To interact with troublesome metal salts, the scale inhibitor chemistries are largely acidic. Phosphate or phosphonate chemistry has been used widely for this purpose, but phosphorus is a now limited global resource. Organic acids and polymeric organic acids and salts can also be used to combat scale build up. For example diethylenetriamine penta(methylene phosphonic) (DETA phosphonate) or aminocarboxylates like ethylene diamine tetra acetic acid (EDTA) form complexes with scale-forming metal cations, preventing the formation of scale.

Similar deposits of scale can also build up in for example evaporative cooling towers, not from a thermodynamically driven precipitation of carbonate salts, but through build up and accumulation from evaporation of hard water, leaving behind both sulfate and carbonate salts. This problem necessitates regular maintenance to remove scale to maintain efficiency. Strong corrosive acids like HCl and sulfamic acid solutions are used to attack these deposits. These strong acids are hazardous and can lead to corrosion of cooling tower loops and plumbing.

Corrosion and rust removers are also comprised of acids. Naval Jelly® is a commercial rust remover example comprised of phosphoric and sulfuric acids. Other commercial products may contain hydrochloric acid. These strong mineral acids can effectively dissolve a buildup of oxidized metal or hydroxides and clean these deposits from the metal surface. Corrosion typically develops on ferrous metals like iron or steel. If the metal comprises a tool or a gear of the machine it can impede the function or action and may lead to accelerated wear and/or damage. It is good for maintenance of tools and equipment to keep them clean and free of rust and corrosion.

The common thread between scale cleaners, scale inhibitors, and rust removers is that these applications all involve acidic remedies. The dissociation of these acids in water can create anions that interact with the metal cations.

2-hydroxypropane-1,2,3-tricarboxylic acid, commonly known as citric acid, is a biobased polyacid used in various food and formulary applications. It gets its name from the citrous fruits it was first isolated from, but now it is most produced at industrial scales as a metabolite of sugar-fed mold. Commercially, it is sold as an anhydrous crystalline solid or a monohydrated crystal. It is ubiquitous in everyday cleaners, cosmetics, pharmaceuticals, food, and polymers.

US 2002/0055439, U.S. Pat. No. 8,022,014, and US 2009/0247432 describe combining choline and citric acid for scale removal.

WO 2022/066818A1 and U.S. Pat. No. 11,168,284 describe reacting citric acid and natural oils for both surfactants and metal ion mitigation in detergents.

Smith et. al. (Chemical Reviews, Volume 114, Issue 21 Nov. 12, 2014) reviews applications of Deep Eutectic Solvents (DES) including citric acid. Deep eutectic solvents are a type of ionic liquid that can freeze at lower temperatures and solvate transition metals, metal salts, including chlorides, oxides, hydroxides. US 2002/0055439, U.S. Pat. No. 8,022,014, US 2009/0247432 describe DES for both inorganic and organic scales or deposits.

Oils are typically not water soluble; they are more dispersive than polar. Making ethoxylated esters of natural oil products like fatty alcohols and acids has been a common theme in making oils water-dispersible without the need for surfactants. Examples of this in patents: U.S. Pat. Nos. 4,731,190, 8,192,726

U.S. Pat. No. 8,192,726 teaches citric acid production, its esters with Guerbet alcohols.

U.S. Pat. No. 8,575,378 teaches making polyols directly from soybean oils. This is useful in making polyurethanes and urethane foams.

### BRIEF DESCRIPTION OF THE DRAWINGS

The patent or application file contains at least one photograph executed in color. As the color photographs are being filed electronically via EFS-Web, only one set of the photographs is submitted. Copies of this patent or patent application publication with color photograph(s) will be provided by the Office upon request and payment of the necessary fee.

FIG. 1 is a graph comparing the dynamic scale loop testing for a brine solution and the brine solution with the ionic resin of the present invention.

FIG. 2 is a graph comparing the scale removal of sulfamic acid and the ionic resin of the present invention.

FIG. 3 is a graph comparing the calcium titrated from solution for sulfamic acid and the ionic resin of the present invention.

FIG. 4 is a photograph of a rusted diamond plate steel sheet showing the effect of exposure with a 10% solution of the ionic resin of the present invention over time.

FIG. 5 is a photograph of timelapse images (0-120 minutes) of 5 rusted steel test cells exposed to 10% solutions of ionic resin of the present invention adjusted to different pHs.

FIG. 6 is a photograph of timelapse images (0-162 minutes) of 8 rusted test cells exposed to the ionic resin of the present invention at different concentrations.

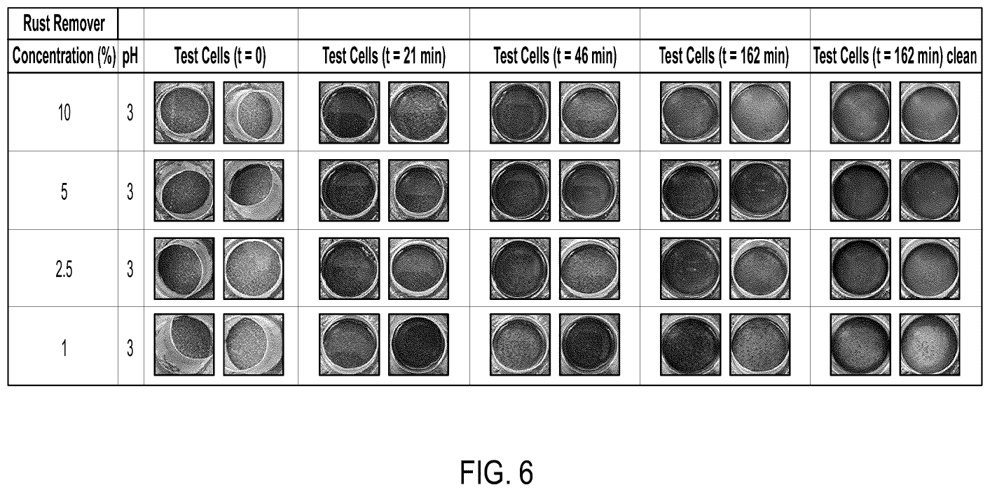

FIG. 7 is a photograph of rusted steel test cells before and after 19 hours exposure to 10% solution of the ionic resin of the present invention and two commercial rust remover products.

FIG. 8 is a photograph of 4 chilled vials of the ionic resin of the present invention with varying amounts of additional choline chloride mixed in tilted on their side to observe cold flow.

### DETAILED DESCRIPTION

This patent describes reaction products of both epoxidized oils and alkanolamines as well as its co-products of the triglyceride (glycerol) can be further esterified with a hydroxy acid like citric acid to form a larger branched polyacid, and/or a deep eutectic solvent. The method detailed is 100% atom efficient and requires no distillation filtration nor separation. The amino carboxylate chemistry is beneficial for the chelation of metal ions, and for its amphiphilic nature.

Plant and animal oils are abundant natural resources that are cheap and readily available. The triglyceride is composed of a mixture of saturated and unsaturated fatty acids. For use in the present application, the points of unsaturation have been transformed into epoxides.

Any suitable plant or animal oils can be used. Suitable plant and animal oils include, but are not limited to, soybean oil, palm oil, olive oil, corn oil, canola oil, coconut oil, cottonseed oil, cashew nutshell liquid, palm kernel oil, rice bran oil, safflower oil, sesame oil, hemp oil, lard, tallow, fish oil, algal oil, and combinations thereof.

One aspect of the process is designated Step 1. Step 1 is a solvent-free amidation and amination of epoxidized triglycerides. Glycerol is produced as a co-product and can be utilized in the next step of this process to reduce waste. This step is preferably solvent-free, but can be performed with solvents.

Suitable amines include, but are not limited to, diethanolamine, ethanolamine, diethylene triamine, methyldiethanolamine, methaolamine, 20amino-2methyl-1-propanol, valinol, sphingosine, N-methanolamine, tyrosinol, or combinations thereof.

Green chemistry reactions also need to have a good atom economy, in that any byproducts from a reaction are minimized. The atom efficiency we can achieve is 100% in that we minimize all waste.

Catalysts can lower the energy required for a chemical reaction to take place. One catalyst that can be used for the amidation reaction is choline chloride (ChCI). The advantages of ChCI are: 1) it is biobased and non-toxic; 2) it can also form deep eutectic solvents with carboxylic acids; and 3) it has a primary hydroxyl such that it can potentially esterify with citric acid. The choline chloride becomes part of the polyester and can also form a deep eutectic solvent with any excess carboxylic acids and alcohols. All of these are advantages for applications requiring interactions with metals. Other catalysts could be used. Suitable catalysts include, but are not limited to, boronic acids, titanium (IV) isopropoxides, Lewis acid oxides, Al₂O₃, TiO₂, ZrCl₄, or combinations thereof.

Another aspect of the process is designated Step 2. Step 2 is the reaction of the step 1 product with citric acid in an excess of citric acid. The product of Step 2 is an acidic solution capable of dissolving in water and producing anions that can interact with metals as described above. Esterification is a widely known process that can be catalyzed with a variety of acid catalysts. Common catalysts are para-toluene sulfonic acid (pTSA) and dodecylbenzenesulfonic acid (DBSA). Dodecyl benzene sulfonic acid may be more energy conservative due to its ability to work at room temperature. (Gang et. al. New J. Chem., 2007, 31, 348-351). Other suitable natural hydroxy acids could be used. Suitable natural hydroxy acids include, but are not limited to, difunctional hydroxy acids and trifunctional hydroxy acids. Suitable difunctional hydroxy acids include, but are not limited to, oleic acid, malonic acid, maleic acid, succinic acid, thiosuccinic acid, glutaric acid, adipic acid, azelaic acid, and combinations thereof. Suitable trifunctional hydroxy acids include, but are not limited to, citric acid, tricarballyic acid, aconitic acid, isocitric acid, or combinations thereof.

The acidic solution has a pH in the range of 2 to 6.5, or 2 to 4, or 2 to 3.

Typically, with esterification reactions, the water of condensation needs to be removed for the reaction to fully complete. This typically involves azeotroping solvents and/or water removal or water separating processes to fully realize a completed ester; otherwise, the reaction will not complete. Elevated temperatures above 100° C. or decreasing the boiling point with the aid of vacuum are additional means for water removal. It is desirable not to completely esterify the product as it will create a harder solid that is hard to process/pump/dissolve in water. Therefore, partial esterification can be performed, and the product can yield a flowable solution that still has good performance. The improved process results in a reduced need for energy, lower temperatures required, no need for vacuum, or azeotroping solvents. As far as energy conservation is concerned, there is no final workup needed to isolate the final product.

It is desirable for the product to have low viscosity. Viscosity can impact synthesis, manufacturing, pumping, and distribution, as well as eventual application and performance in water-based systems. Viscosity can be reduced by including a polar solvent like acetone. The viscosity of the final product can also be controlled by proper selection of the reagent ratios. The ratio of ingredients in examples 7 and 8 with citric acid and a ratio of acid to hydroxyl groups 3-4:1 produces a product with an easy-to-process viscosity. The viscosity can also be controlled by dilution with solvent. After the reaction, the material can be diluted in ketones, alcohols, water, or combinations thereof. One suitable ketone is acetone. In some embodiments, the final viscosity with 25% acetone solvent has a dynamic viscosity of less than or equal to 5000 mPa·s measured with a cone and plate rheometer in the range of 20° C. and 60° C. Without the solvent, the viscosity could be much higher (even a solid). The product desirably is pumpable with standard processing equipment. The dynamic viscosity measurement with temperature show where the product might be most fluid like. Deviations from desirable ratios or conditions may result in a product that is not pumpable.

Other aspects of this invention are the method of diluting the ionic resin composition in water to make a solution for use as a scale cleaner, scale inhibitor, or rust remover. The addition of additional ChCI (ore than what is required to catalyze step 1) can interact with the excess acid groups and create a eutectic solvent mixture with improved pour point.

Polar solvents including, but not limited to, water, acetone, isopropanol, ethanol, methanol, and the like can be used.

Another aspect of the invention is using the product for cleaning, for example, rust removal and/or scale cleaning. In some embodiments, the material is diluted to a solids content is ideally between 5% and 40% actives. For safety, the acid can be partially neutralized with a base. The optimal pH adjustment for rust remover should be between 2-6.5 pH. Ideally, the pH should be less than 5 for good rust removal performance.

In practice, a scale inhibitor is needed at much lower levels. The solids content is typically diluted between 1 and 5000 ppm for scale inhibition. Most likely in the 10-1000 ppm range.

These solutions may contain additional additives surfactants, and solvents to aid in cleaning, stability, clarity, and performance. Additives may also take the form of rheological aids, corrosion inhibitors or other scale inhibitors, emulsifiers, pourpoint depressants, biocides, salts, acids, pH buffers, chelators, or combinations thereof.

One aspect of the invention is a process of producing an acidic ionic resin. In one embodiment, the process comprises: providing an alkanol amine polymer, an alkanol amide polymer, or combinations thereof, and glycerol; reacting the alkanol amine polymer, the alkanol amide polymer, or combinations thereof, and the glycerol with a natural hydroxy acid to produce an acidic solution comprising an esterified alkanol amine polymer, an esterified alkanol amide polymer, or combinations thereof. The acidic ionic resin has an acid value greater than or equal to 100, or greater than or equal to 150, or greater than or equal to 200, or greater than or equal to 250, or greater than or equal to 300, or greater than or equal to 350, or greater than or equal to 400, or greater than or equal to 450, or greater than or equal to 500, or greater than or equal to 550, or greater than or equal to 600, or greater than or equal to 625.

Resins used for coatings or adhesives typically have an acid value less than 100; polyesters are typically in the range of 25-30. The acidic ionic resin of the present invention has an acid value greater than or equal to 100 so that it can be used for scale inhibition, desirably with even higher acid values.

In some embodiments, the natural hydroxy acid comprises citric acid, tricarballyic acid, aconitic acid, isocitric acid, ricinoleic acid, malonic acid, maleic acid, succinic acid, thiosuccinic acid, glutaric acid, adipic acid, azelaic acid, or combinations thereof.

In some embodiments, reacting the alkanol amine polymer, the alkanol amide polymer, or combinations thereof, and the glycerol with the natural hydroxy acid takes place in the presence of an acid catalyst.

In some embodiments, the acid catalyst comprises para-toluene sulfonic acid, dodecylbenzenesulfonic acid, or combinations thereof.

In some embodiments, reacting the alkanol amine polymer, the alkanol amide polymer, or combinations thereof, and the glycerol with a natural hydroxy acid produces a partially esterified alkanol amine polymer, an esterified alkanol amide polymer, or combinations thereof.

In some embodiments, the process further comprises: diluting the acidic solution with a solvent.

In some embodiments, the acidic solution has a viscosity of less than or equal to 5000 mPa·s.

In some embodiments, the solvent comprises a ketone, an alcohol, water, or combinations thereof.

In some embodiments, the acidic solution further comprises: a surfactant, a solvent, a rheological aid, a corrosion inhibitor, a scale inhibitor, an emulsifier, a pourpoint depressant, a biocide, a salt, a pH buffer, a chelator, or combinations thereof.

In some embodiments, providing an alkanol amine polymer, an alkanol amide polymer, or combinations thereof, and glycerol comprises: reacting an epoxidized natural oil with an amine to form the alkanol amine polymer, the alkanol amide polymer, or combinations thereof, and the glycerol.

In some embodiments, reacting the epoxidized triglyceride with the amine comprises reacting the epoxidized triglyceride with the amine in the presence of a catalyst.

In some embodiments, the catalyst comprises choline chloride.

In some embodiments, reacting the epoxidized triglyceride with the amine takes place in the absence of a solvent.

In some embodiments, the amine comprises diethanolamine, ethanolamine, diethylene triamine, methyldiethanolamine, methaolamine, 2-amino-2-methyl-1-propanol (AMP), valinol, sphingosine, N-methanolamine, tyrosinol, or combinations thereof.

In some embodiments, an equivalents of amine is greater than or equal to a sum of epoxy group equivalents and fatty acid group equivalents in the alkanol amine polymer, the alkanol amide polymer, or combinations thereof, and the glycerol. If the amine groups are x, the epoxy groups are y, and the fatty acid groups are z, then x*β=y+z, where β represents the amine excess which is typically between 1-1.5. A β value of about 1.1 is desirable.

In some embodiments, the process further comprises adding choline chloride to the acidic solution after reacting the alkanol amine polymer, the alkanol amide polymer, or combinations thereof, and the glycerol with the natural hydroxy acid.

In some embodiments, reacting the alkanol amine polymer, the alkanol amide polymer, or combinations thereof, and the glycerol with the natural hydroxy acid takes place under esterification reaction conditions comprising: a temperature in a range of 50° C. to 170° C.; or a ratio of the natural hydroxy acid to a hydroxyl equivalent in the alkanol amine polymer, the alkanol amide polymer, or combinations thereof, and the glycerol is greater than 1:1; or combinations thereof. The ratio of the natural hydroxy acid to a hydroxyl equivalent is greater than 1:1 so that product has acid functional and to reduce crosslinking for lower viscosity. Typical ranges for the ratio of the natural hydroxy acid to a hydroxyl equivalent is greater than 1:1, or greater than 1.1:1, or 1-4:1, or 1-3:1, or 1-2:1, or 2-3:1, or 3-4:1. For citric acid, a ratio of greater than 3-4:1 is overindexed and amounts to diluting with citric acid. For oil and gas applications, the acid value should be greater than or equal to 100, or greater than or equal to 150, or greater than or equal to 200, or greater than or equal to 250, or greater than or equal to 300, or greater than or equal to 350, or greater than or equal to 400, or greater than or equal to 450, or greater than or equal to 500, or greater than or equal to 550, or greater than or equal to 600, or greater than or equal to 625. For citric acid, which has three acid groups, it is preferable that two are not esterified.

In some embodiments, the acidic solution has a pH in a range of 2 to 6.5.

In some embodiments, a solids content of the acidic solution is in a range of 5% to 40%.

In some embodiments, a solids content of the acidic solution is in a range of 10 to 1000 ppm.

### EXAMPLES

### Example 1—Step 1 Batch Process and Glycerol Rinse

In a 250 mL 3-neck roundbottom flask, fitted with an overhead mixer, inert gas nitrogen purge, and a temperature controller—heating mantle—and thermocouple network, 103.48 grams diethanolamine and 120.05 grams of ESBO is charged. At 9 am, the solution was heated to 60° C. for 1 hour (monitor FTIR), and the temperature was increased to 80° C. It was cooled to 65° C., and 2.54 grams of sodium methoxide and 7.8 grams of methanol were added. It was reacted over 24 hours, and the heat and stirring were turned off at 9 μm the next day. It was directly wash with saturated NaCl brine to remove excess glycerol, catalyst and diethanolamine after heating to 60° C. to thin it out. The reaction was monitored FTIR over time to show amidation and epoxy reduction. The rinsing step is not preferred.

### Example 2—Step 1 Reaction Choline Chloride Catalyzed at 120° C.

172.11 grams of ESBO, 147.29 grams of diethanolamine, and 15.99 grams of ChCl were charged into a 500 mL kettle with overhead stirring and argon purge. The heating mantle temperature was set to 120° C., and it was stirred overhead while under the argon purge. The solution started white and turbid, and slowly turned amber with time at temperature. The reaction started at noon on one day, and it was stopped after about 20 hours. FTIR was used to confirm amide formation and reduction in epoxy.

### Example 3—Step 2 Reaction with Toluene

20.11 grams of the material from step 1 of Example 2, 46.0 grams of anhydrous citric acid, 120 grams of toluene, and 1.32 grams of pTSA were charged into a 3-neck 500 mL roundbottom flask with overhead mixer and Dean-Stark trap (DS). DS trap with toluene It was heated to 125° C. overnight, under argon purge. The water of condensation was monitored with time of reaction. The results are shown in Table 1.

TABLE 1

| Hours | water trapped mL | Appearance |
|---|---|---|
| 0.00 | 0.00 | gummy solids |
| 2.00 | 1 | Taffy |
| 2.43 | 1.6 | tan doughy semi-solid |
| 18.00 | 4 | hard almost solid |

The product after distillation was very hard and not flowable.

### Example 4—Step 1 Reaction at 150° C. for 1 Hour

In an argon purged round bottom flask with a magnet for mixing, 106.55 grams of ESBO, 91 grams of diethanolamine, 9.88 grams of ChCl were charged. A loose stopper was placed over the flask opening, and the flask was placed in a 150° C. preheated silicone bath on a mixing hotplate. After 15 minutes, a timer was set for 1 hour. The product was allowed to cool to room temperature. Infrared analysis shows a clear ester-to-amide shift.

### Example 5—Step 1 Batch Reaction Heating Only

373.75 grams of ESBO, 319.36 grams of diethanolamine, and 29.85 grams of ChCl were charged into a 1-liter kettle fitted with a heating mantle-thermocouple-temperature controller network, argon purge, and an overhead stirrer. The temperature controller was controlled and logged by computer with J-Kem™ software. The reactor was heated to 120° C. About 10 minutes after reaching the set temperature, the exothermic reaction caused the temperature of the contents to increase to over 160° C.

### Example 6—Step 1 Reaction Plug-Flow Reactor

The plug-flow reactor is a safer way to handle exothermic reactions in that the volume of heated product is smaller than the volume of heating fluid. This will inhibit runaway exothermic reactions. The other benefit is that heat of reaction will maintain the reactor temperature so that minimal energy is needed for continuous batches.

In a 1-liter mixing kettle reactor, 639.3 grams of epoxidized soybean oil, 546.0 grams of diethanolamine, and 59.3 grams of choline chloride were charged. With a peristaltic pump, purge with argon gas, pull the contents of the first kettle through a stainless-steel loop in a 4-liter kettle full of high-temperature radiator fluid. The second kettle was fitted with an overhead mixer in the cavity. The flow rate of the pump was set to 0.5 mL/minute. The temperature of the second kettle was set to 170° C.

### Example 7—Step 1 Batch Reaction at 120° C. in Oil Bath

In a 1-liter reaction kettle, 513 grams of epoxidized soybean oil, 438 grams of diethanolamine, and 47 grams of choline chloride were charged. The reactor was suspended in a heated oil bath with a thermocouple-controller network set to 120° C., overhead stirrer, and dry inert argon gas purge. The material was brought to temperature and allowed to react at temperature for 20 hours. The product turned dark amber and had a notable viscosity increase. Infrared analysis confirmed characteristic ester peaks dropped and the formation of amide peaks.

### Example 8—Step 2 Reaction with No Reflux

80 grams of the product of Example 3, along with 235.4 grams of citric acid monohydrate, 105.65 grams of acetone, and 1.2 grams of dodecyl benzene sulfonic acid were charged into a 3-neck 500 mL round bottom flask fitted with an overhead stirrer, thermocouple, and stopper. The flask was placed in a temperature-controlled oil bath set to 50° C. The headspace of the flask was purged with dry inert argon gas. Upon initial mixing, the consistency was like that of thick applesauce; after an hour of mixing, the material was more homogeneous. The next day, the material was extremely uniform with no signs of crystals of citric acid remaining. The product was reminiscent in color and consistency to maple syrup.

### Example 9—Performance with Scale Inhibition

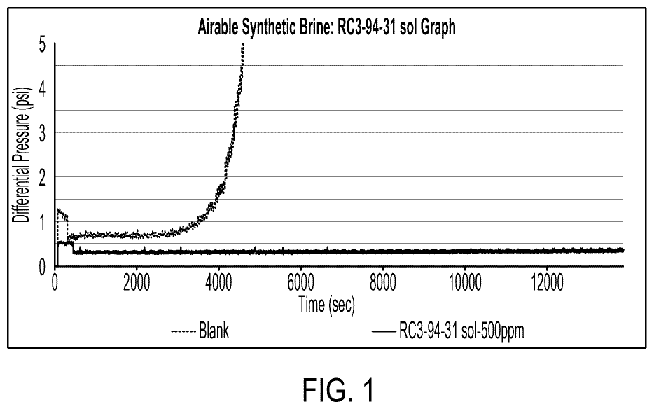

Dynamic scale loop testing measures the pressure buildup with incompatible brines as they are thermodynamically driven to precipitate while warming up. FIG. 1 shows a 10% active formulation that was diluted on-site to 500 ppm. An increase in pressure to 5 psi during this test indicates a failure in performance. FIG. 1 shows that the brine will cause failure. However, when the scale inhibitor formulation is added to the brine, the inhibitor there is only a minimal pressure increase.

### Example 10 Performance with Scale Removal

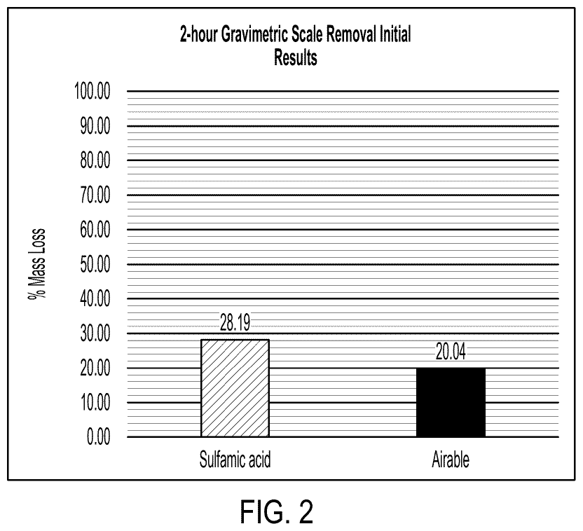

In order to simulate dynamic fluid cleaning of a cooling tower, a mini simulation was mocked up to imitate scale removal through recirculating water pumping. Hard water scale buildup from an actual cooling tower was collected and ground to the consistency of sand. A recirculating flow loop made with Soxhlet extraction thimble full of this ground scale and recirculating silicone tubing and peristaltic pump. The loop was for 2 hours, and fluid samples were collected every 30 min. The scale was rinsed with water and dried for gravimetric analysis of scale solids. A 20% solution of the scale cleaner of the product of Example 8 was compared to a 10% solution of sulfamic acid. The results showed gravimetrically that the scale remover of the present invention works and is about 70% as effective as the strong sulfamic acid, as illustrated in FIG. 2.

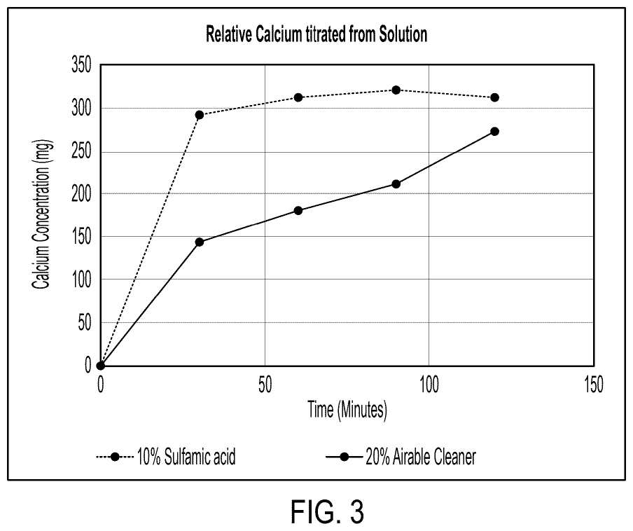

Titrations made on intermittent samples taken during the 2-hour time period also suggests that the material works as a scale cleaner and for pulling calcium into solution. FIG. 3 shows that after 30 minutes, the sulfamic acid nearly peaked, and after 2 hours the formulation of the present invention still appears to be working.

### Example 11 Rust Removal Performance

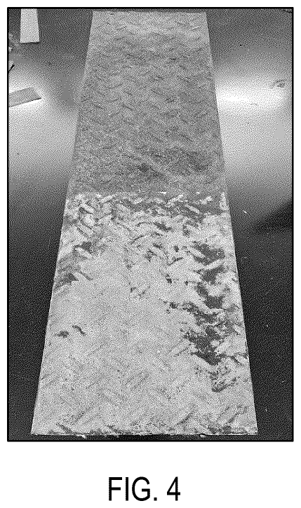

A 10% solution of the product of Example 8 in water was prepared and used to treat rusted diamond plate by wrapping half of the plate in paper towels and soaking them with the solution. The wet towels were wrapped in saran wrap to keep the solution from drying. After a day, the treated section was rinsed clean, and the process was repeated. After the second treatment, the panel was rinsed again, lightly scrubbed, and dried. The treated bottom half was visibly cleaner as shown in FIG. 4.

Rusted steel panels from a scrap yard were uniformly corroded by natural weathering (exposure to rain water and air). Cylinders made from small plastic cups with their bottoms cut off were epoxied to the surfaces of the panels to make a series of uniform test cells on the same panel. After full curing of the epoxy, the test cells were filled with simple rust remover formulations. The degree of rusting can vary from panel to panel so each set of comparisons was performed on a new panel. Variations in time, concentration, and pH were made to see any visual effects on rust removal on steel. Additionally, comparisons to commercial rust removers were made. The volume of cleaner was consistent in all test cells (30 mL), and the rusted surface exposed in the cells was 2 inches. The temperature in the laboratory was maintained between 68-71° C.

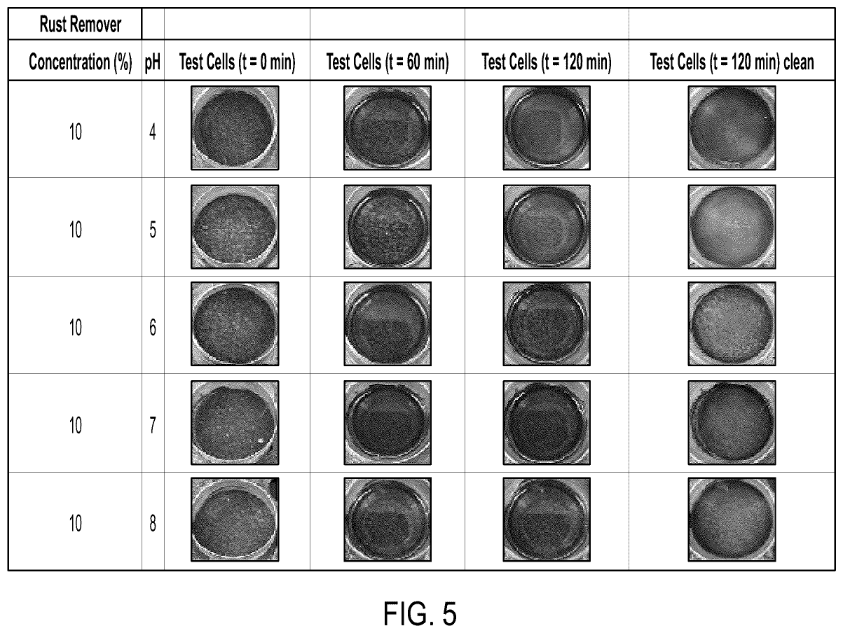

FIG. 5 shows the effect of adjusting pH with triethanolamine (TEA). The initial pH of a 10% solution of Example 8 was about 3. It was observed that the pH was still effective up to a pH of 5. Table 2 represents how clean these test cells look in a scale from D to A (rusty to clean respectively). The lower the pH the better the rust removing performance.

TABLE 2

| | | 0 min | | | 120 min |
|---|---|---|---|---|---|
| Concentration | | (before | 60 min | 120 min | after rinsing |
| of example 8 | pH | exposure) | exposure | exposure | and drying |
| 10% | 4 | D | C | B | A |
| 10% | 5 | D | C | B | A |
| 10% | 6 | D | D | C | C |
| 10% | 7 | D | D | D | C |
| 10% | 8 | D | D | D | C |

It was also observed that although the product was effective at removing rust at low concentrations, the surfaces were cleaner with higher concentration of cleaner in water. Table 3 represents how clean these test cells look in a scale from D to A (rusty to clean respectively).

TABLE 3

| | | | | | 162 min |
|---|---|---|---|---|---|
| | | | | | after |
| | 0 min | 21 min | | | rinsing |
| Concentration | (before | after | 46 min | 162 min | and |
| of example 8 | exposure) | exposure | exposure | exposure | drying |
| 10% | D | D | C | B | A |
| 5% | D | D | D | C | A |
| 2.5% | D | D | D | C | B |
| 1% | D | D | D | C | B |

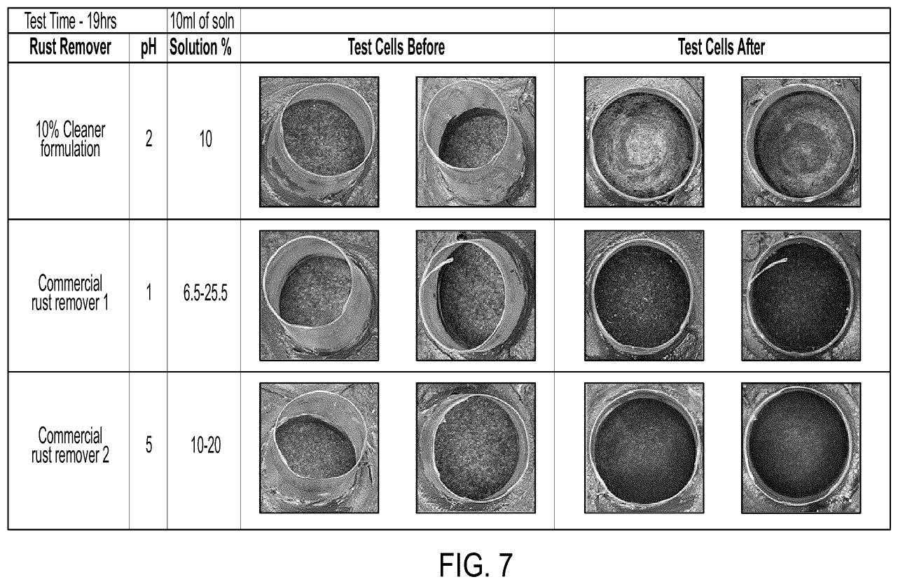

FIG. 7 is a comparison to commercial rust remover products.

The cleaner made from the ionic resin of Example at 10% solids in water seemed comparable to or better than commercial rust removers. Table 4 represents how clean these test cells look in a scale from D to A (rusty to clean respectively).

TABLE 4

| | Before | After |
|---|---|---|
| 10% solution of Example 8 | D | A |
| Commercial Rust remover 1 | D | B |
| Commercial Rust Remover 2 | D | A |

### Example 12 Step 2 Batch with Honeybee Polyol™

21.36 grams of Honeybee HB230 Polyol™ (a polyol made from soybean oil according to U.S. Pat. No. 8,575,378, available from MCPU Polymer Engineering), 8.11 grams of glycerol, and 51.85 grams of citric acid monohydrate were charged to a 250 mL roundbottom flask. The mixture was heated overnight at 89° C. with a 3 Angstrom molecular sieve distillation trap, dry inert argon purge, and mechanical stirring. it was rotary evaporated the next day up to 98° C. The product was relatively thin and brown, and transferred from the reaction vessel very easy. It flowed at room temp like molasses.

### Example 13 Improving Upon DES Qualities by Adding More ChCl

A desirable method of producing the product involves adding additional choline chloride crystals in the following manner.

TABLE 2

| Sample | 1 | 2 | 3 | 4 |
|---|---|---|---|---|
| Inventive product | 5 | 5 | 5 | 5 |
| Choline chloride (grams) | 2.5 | 1.5 | 0.75 | 0 |

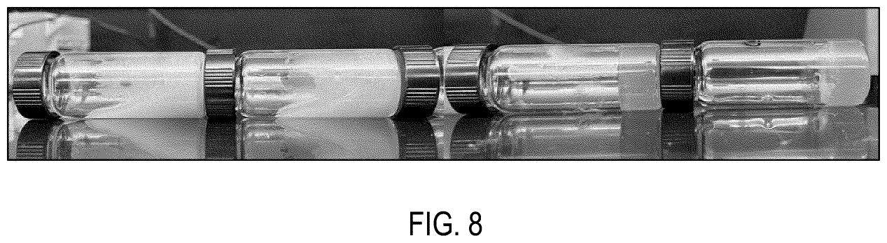

The mixtures were all frozen below 4° C. for about 20 minute, then immediately put on the tabletop on their sides. The samples with higher additional loadings of ChCI began to flow faster, suggesting that their melting points were elevated above that of the inventive product alone. Depression of freezing point is a good indicator of a eutectic solvent mixture. Samples 1-4 are shown in FIG. 8 from left to right.

By “about” we mean within 10%, or within 5%, or within 1% of the value listed.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process of producing an acidic ionic resin comprising:
providing an alkanol amine polymer, an alkanol amide polymer, or combinations thereof, and glycerol;
reacting the alkanol amine polymer, the alkanol amide polymer, or combinations thereof, and the glycerol with a natural hydroxy acid to produce an acidic solution comprising an esterified alkanol amine polymer, an esterified alkanol amide polymer, or combinations thereof having an acid value greater than or equal to 100.

2. The process of claim 1 wherein the natural hydroxy acid comprises citric acid, tricarballyic acid, aconitic acid, isocitric acid, ricinoleic acid, malonic acid, maleic acid, succinic acid, thiosuccinic acid, glutaric acid, adipic acid, azelaic acid, or combinations thereof.

3. The process of claim 1 wherein reacting the alkanol amine polymer, the alkanol amide polymer, or combinations thereof, and the glycerol with the natural hydroxy acid takes place in the presence of an acid catalyst.

4. The process of claim 3 wherein the acid catalyst comprises para-toluene sulfonic acid, dodecylbenzenesulfonic acid, or combinations thereof.

5. The process of claim 1 wherein reacting the alkanol amine polymer, the alkanol amide polymer, or combinations thereof, and the glycerol with a natural hydroxy acid produces a partially esterified alkanol amine polymer, an esterified alkanol amide polymer, or combinations thereof.

6. The process of claim 1 further comprising:
diluting the acidic solution with a solvent.

7. The process of claim 6 wherein the acidic solution has a viscosity of less than or equal to 5000 mPa·s.

8. The process of claim 6 wherein the solvent comprises a ketone, an alcohol, water, or combinations thereof.

9. The process of claim 1 wherein the acidic solution further comprises:
a surfactant, a solvent, a rheological aid, a corrosion inhibitor, a scale inhibitor, an emulsifier, a pourpoint depressant, a biocide, a salt, a pH buffer, a chelator, or combinations thereof.

10. The process of claim 1 wherein providing an alkanol amine polymer, an alkanol amide polymer, or combinations thereof, and glycerol comprises:
reacting an epoxidized natural oil with an amine to form the alkanol amine polymer, the alkanol amide polymer, or combinations thereof, and the glycerol.

11. The process of claim 1 wherein reacting the epoxidized triglyceride with the amine comprises reacting the epoxidized triglyceride with the amine in the presence of a catalyst.

12. The process of claim 11 wherein the catalyst comprises choline chloride.

13. The process of claim 10 wherein reacting the epoxidized triglyceride with the amine takes place in the absence of a solvent.

14. The process of claim 10 wherein the amine comprises diethanolamine, ethanolamine, diethylene triamine, methyldiethanolamine, methaolamine, 2-amino-2-methyl-1-propanol, valinol, sphingosine, N-methanolamine, tyrosinol, or combinations thereof.

15. The process of claim 10 wherein an equivalents of amine is greater than or equal to a sum of epoxy group equivalents and fatty acid group equivalents in the alkanol amine polymer, the alkanol amide polymer, or combinations thereof, and the glycerol.

16. The process of claim 1 further comprising:
adding choline chloride to the acidic solution after reacting the alkanol amine polymer, the alkanol amide polymer, or combinations thereof, and the glycerol with the natural hydroxy acid.

17. The process of claim 1 wherein reacting the alkanol amine polymer, the alkanol amide polymer, or combinations thereof, and the glycerol with the natural hydroxy acid takes place under esterification reaction conditions comprising:
a temperature in a range of 50° C. to 170° C.; or
a ratio of the natural hydroxy acid to a hydroxyl equivalent in the alkanol amine polymer, the alkanol amide polymer, or combinations thereof, and the glycerol is greater than 1:1; or
combinations thereof.

18. The process of claim 1 wherein the acidic solution has a pH in a range of 2 to 6.5.

19. The process of claim 1 wherein a solids content of the acidic solution is in a range of 5% to 40%.

20. The process of claim 1 wherein a solids content of the acidic solution is in a range of 10 to 1000 ppm.
